(19) United States
(12) Patent Application Publication
(10) Pub. No.: US 2003/0148858 A1
(43) Pub. Date: Aug. 7, 2003

(54) Balance stabilizing device

(76) Inventor: Steven D. Jones, E. Grand Rapids, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/061,667

(22) Filed: Feb. 1, 2002

(51) Int. Cl. A47D 13/04; A61H 3/00

(52) U.S. Cl. 482/66

(57) ABSTRACT

A formed tubular frame which has a pair of generally U-shaped members joined at an acute angle such that a lower of the members engages the skating or support surface while the upper member extends forwardly and upwardly to define a handle for the user. The U-shaped members define an open area in which a user can stand and manipulate their legs for skating or otherwise moving while placing their center of gravity well within the supporting frame to provide lateral and fore and aft support and allow the user to place weight on the device as necessary to assist in stabilizing their balance.

### BACKGROUND OF THE INVENTION

The present invention relates to a balance stabilization device and particularly one which is useful as a training aid for skaters.

Skating, including inline skating, roller skating, and ice skating, has become an increasingly popular sport with both young and old alike. Nonetheless, beginning skaters, until the balance and skills are mastered, are unfortunately somewhat prone to falling, which can be both injurious, embarrassing, and does not instill confidence in furthering their skating abilities. Younger skaters, particularly when ice skating, can be somewhat fearful of falling on the ice and injuring themselves. Although there has been many proposed paraphernalia for assisting in the training of skating, many skating aids have employed frames with multiple sections of tubing having numerous coupling joints; do not nest for stacking multiple units in an ice arena, for example; do not properly protect the user by placing the user's center of gravity well within the support framework of the device or, in some cases, have relatively sharp edges and projections which could actually cause injury in the event the user accidentally fell.

Accordingly, there exists a need for an improved balance stabilizing device which can be used for assisting beginning skaters and, if equipped with rollers, also employed by elderly or infirm persons to assist them in mobility.

### SUMMARY OF THE INVENTION

The system of the present invention satisfies this need by providing a formed tubular frame which has a pair of generally U-shaped members joined at an acute angle at the rear of the device such that a lower of the members engages the skating or support surface while the upper member extends forwardly and upwardly to define a handle for the user. The U-shaped members define an unobstructed open area in which a user can stand and manipulate their legs for skating or otherwise moving while placing their center of gravity well within the supporting frame to provide lateral and fore and aft support while also allowing the user to place weight on the device as necessary to assist in stabilizing their balance.

In one embodiment of the invention, each leg of the lower generally U-shaped frame member preferably includes a raised section facing the rear of the device to receive a supporting brace extending between the raised section of the lower member and the handle to provide rigidity to the structure. In a preferred embodiment also, the handle includes a comfortable resilient grip for use in supporting the user. With such construction, a practically joint-free, smoothly curved tubular frame is provided which can be employed for assistance in learning ice skating, or, when equipped with rollers for assisting in inline or roller skating and/or assisting the mobility of infirm or elderly persons.

The device is nestable such that at a facility, such as an ice skating rink, a plurality of the devices can be stored in a minimum storage area and easily singulated for use by individuals, for example, renting such a device. Another advantage of this design is that the upper member slopes forward and upward, allowing users of various heights to grip the handle in various locations.

These and other features, objects and advantages of the present invention will become apparent upon reading the following description thereof together with reference to the accompanying drawings.

### BRIEF DESCRIPTION OF THE DRAWINGS

FIG. 1 is a perspective view of a stability assistant device embodying the present invention, shown in use as an ice skating aid;

FIG. 2 is a right side elevational view of the device shown in FIG. 1;

FIG. 3 is a rear elevational view of the device shown in FIG. 1;

FIG. 4 is a right side elevational view of a plurality of the devices, shown stacked in a nested position for storage;

FIG. 5 is a rear elevational view of an alternative embodiment of the device;

FIG. 6 is a rear elevational view of yet another embodiment of the device;

FIG. 7 is a rear elevational view of yet a further embodiment of the device;

FIG. 8 is an enlarged fragmentary perspective view of the reinforcing member for each side of the device, as seen in FIGS. 1-3;

FIG. 9 is a fragmentary enlarged view of an alternative embodiment of the reinforcing member;

FIG. 10 is yet another alternative embodiment of the reinforcing member;

FIG. 11 is a right side elevational view of an alternative embodiment of the stability device which includes rollers;

FIG. 12 is a right side perspective view of another embodiment of the device; and

FIG. 13 is an enlarged cross-sectional view taken along section line XIII-XIII of FIG. 12.

### DETAILED DESCRIPTION OF THE PREFERRED EMBODIMENT

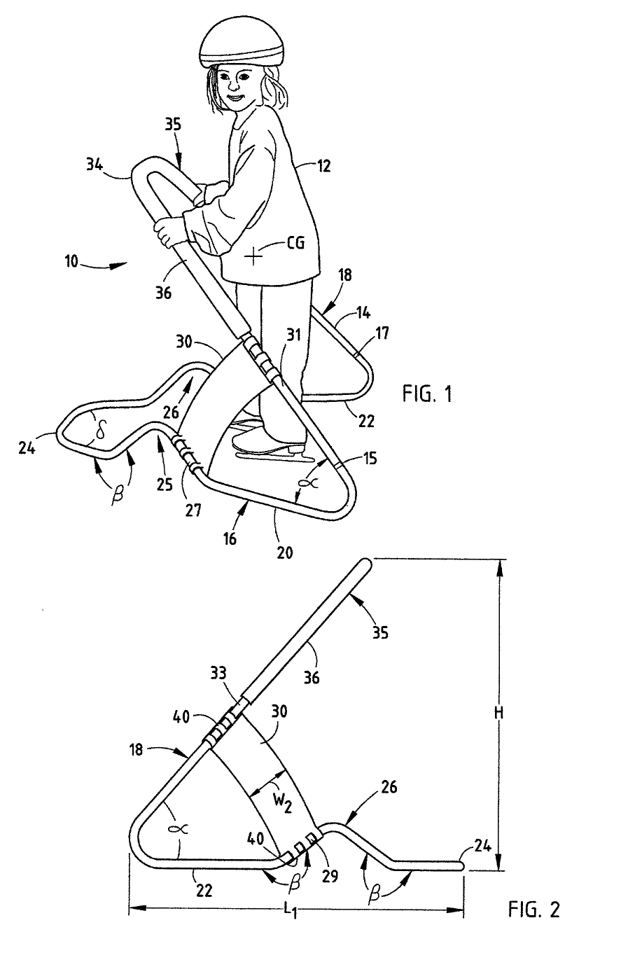

Referring initially to FIG. 1, there is shown a balance stabilizing device 10 embodying the present invention, which is used by an individual 12 for assistance in learning to ice skate. Device 10 comprises an integral tubular framework 14 which includes a lower, generally U-shaped member 16 and an upper, generally U-shaped member 18 which is integrally attached to the lower member 16, forming an upwardly inclined acute angle α, as seen in FIGS. 1 and 2, which is from about 40° to about 50° and, in the preferred embodiment, 47°. The lower and upper members 16 and 18 define the integral tubular frame 14, which is made of formed steel, such as a 1″ OD 16-gauge zinc-plated steel tubes which may be suitably powder coated with polyurethane to withstand the harsh environment of an ice skating rink, for example, in the embodiment shown in FIGS. 1-7.

In one embodiment of the invention, the upper member 18 is joined to the lower member 16 by at least one and perhaps two telescopic connections 15, 17 (FIG. 1) to allow the members to be separated into sections for shipment. When assembled and in use, the weight of an individual leaning on the device provides forces which maintain the junction, although in some embodiments it may be desirable to extend a locking fastener between the telescopic tube sections. The telescopic connections 15 and 17 can be conventionally formed by compressing the ends of one of the members, such that its outer diameter fits within the end of the other member. They can subsequently also be locked together by swaging or using a fastener.

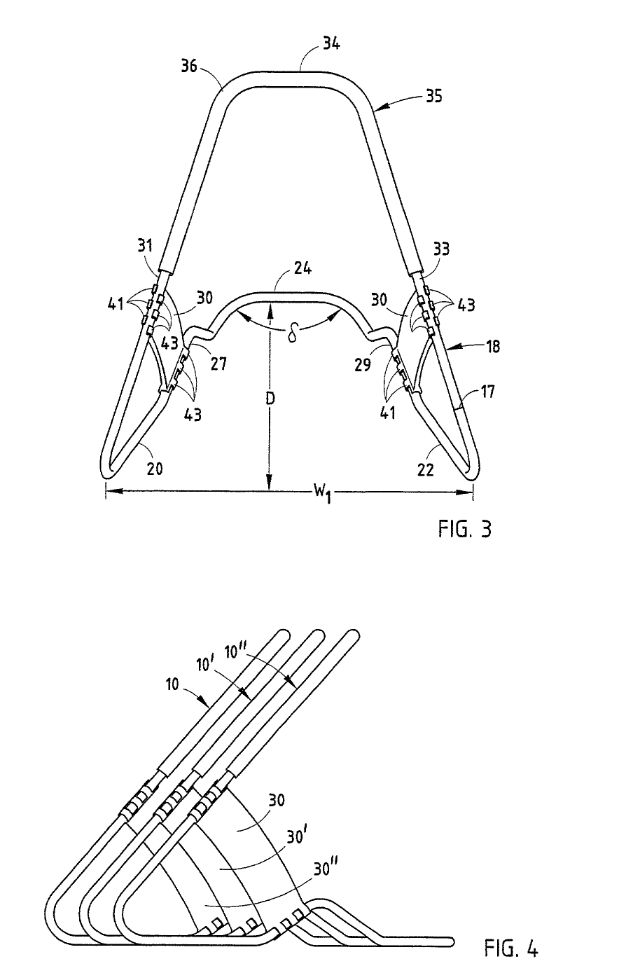

The lower member 16 includes, as viewed in FIG. 1, a left side runner 20 and a forwardly converging right side runner 22 integrally joined by a center forwardly projecting section 24. The lower surfaces of members 20, 22 and 24 define runners which contact the ice surface. Runners 20 and 22 are each interrupted by inverted V-shaped raised sections 25 and 26, respectively, which extend upwardly from the horizontal contact surface at an angle β of from about 210° to 230° and preferably 216°. Runners 20 and 22 converge at the center section at an angle δ of approximately 45, as seen in FIGS. 1 and 3.

The raised sections 25, 26 provide a gap in runners 20 and 22 of about 11 inches and provide an inclined rear wall 27, 29 on runners 20, 22, respectively, for attaching a reinforcing member 30 on each side of the device to provide additional strength for the upper handle defining member 18 with respect to the lower member 16 as weight is placed on the handle 35 consisting of the upper forward extension of upper member 18. Additionally, raised sections 25, 26 reduce the contact area with the ice and, therefore, make the device slide more easily.

The overall length L₁ of the lower runners, as seen in FIG. 2, is, in the preferred embodiment of the invention, 36 inches, while the height H is approximately 32 inches for use by smaller individuals. The dimensions can be somewhat varied if larger models are desired for adults. The relatively large open footprint area of the device is best seen in FIG. 3 and has a width W₁ of about 31 inches and a depth D corresponding to L₁ of 36 inches, thereby providing a significantly open area into which a skater can step, as seen in FIG. 1, with the skater's center of gravity CG (FIG. 1) being positioned well between runners 20, 22 of the lower member 16 and arms 31 and 33 of the upper member 18. The handle 35 is defined by integral upper member 18 with arms 31 and 33 joined at a center section 34. The handle 35 defined by the upper forward end of upper member 18 is covered with a PVC coating 36, which is applied in a dip process and which provides a secure but comfortable grip for the user. The PVC grip 36 extends sufficiently along the handle 35 to allow individuals of different sizes to use the device.

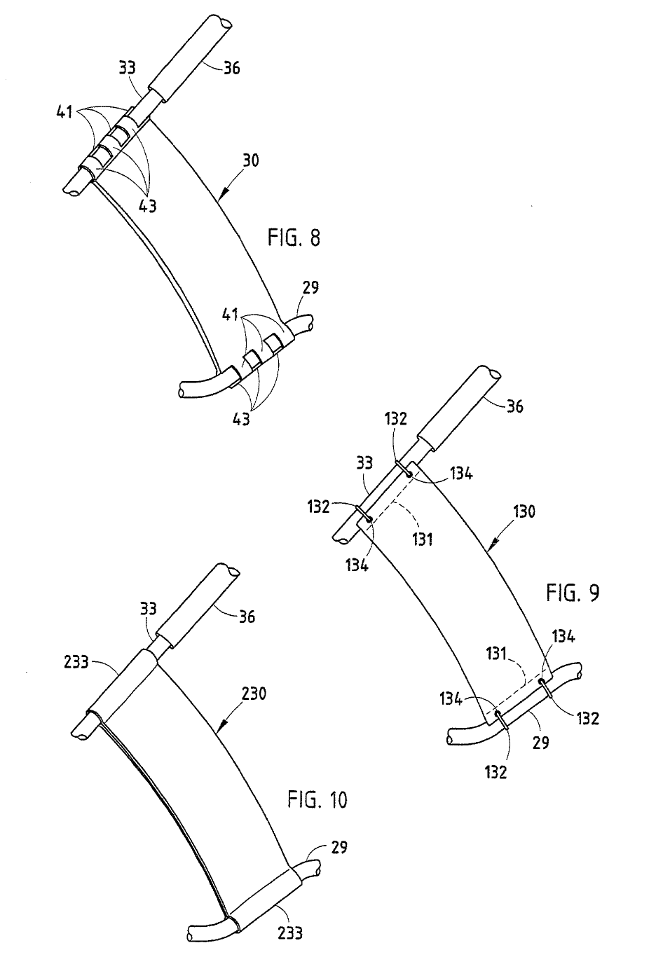

Each of the support members 30 are preferably made of injection molded polypropylene (or nylon) having a width W₂ (FIG. 2) of about 5 inches and an I-beam shaped cross section with a center thickness of about 0.2″, terminating on angled ends which conform to the angle α between the lower member 16 and upper member 18 of the device 10. The supports 30 include coupling members 40 at each end which can, as best seen in FIGS. 3 and 8, comprise a plurality of alternately staggered opposed arcuate open claws 41 and 43 to snap-fit over the tubular members 16 and 18. Thus, on the left side of the device 10, member 30 snap-fits between inclined section 27 of runner 20 and the inclined leg 31 of upper member 18, while the right side member 30 similarly engages the upper inclined section 29 of runner 22 and the inclined leg 33 of upper member 18. Reinforcing members 30 provide significant rigidity against vertical compression forces applied by an individual using the device, and the device can withstand compression forces of at least up to 250 pounds on handle 35.

FIG. 4 illustrates how three such identical devices 10, 10′, and 10″ can be nested for storage in a facility, such as an ice skating rink, where the rink owners may want to purchase a plurality of such devices for rental or sale to individuals. The nesting feature also allows them to be stacked for transport on a cart.

Reinforcing member 30 can take on the form shown in FIGS. 1-3 and 8 or can comprise, as seen in FIG. 9, a member 130 which can also be injection molded and have semicylindrical sockets 131 (shown in phantom in FIG. 9) which surround and circumscribe approximately half of each of the tubular frame sections 29 and 33. In this embodiment, a pair of spaced apertures 134 are formed in each end of the support 130 to receive polymeric wire ties 132, which can be employed to secure the support member 130 to the frame member sections. Rawhide string could also be employed in place of ties 132. Also, the supports could be riveted to the tubular frames from inside the frame (i.e. above the lower frame and below the upper frame). In such an embodiment, the inverted V-shaped section may not be necessary, and the supports are extended to a straight lower frame as in the embodiment now described in connection with another embodiment of the invention shown in FIGS. 12 and 13.

In an alternative embodiment shown in FIG. 10, a reinforcing member 230 can be injection molded of polypropylene or nylon to integrally surround tubular sections 29 and 33 once the device 10 has been assembled and for such purpose define a circumferential collar 233 at upper and lower ends which couple and lock support member 230 to the tubular framework of the device. In this embodiment, either the junction of collar 233 to tubular frame section 33 is sufficiently loose to allow assembly and disassembly of the frames 16, 18 or frames 16 and 18 are permanently secured to one another during manufacturing. The support member 230 can also be joined to itself or the frame with traditional fasteners.

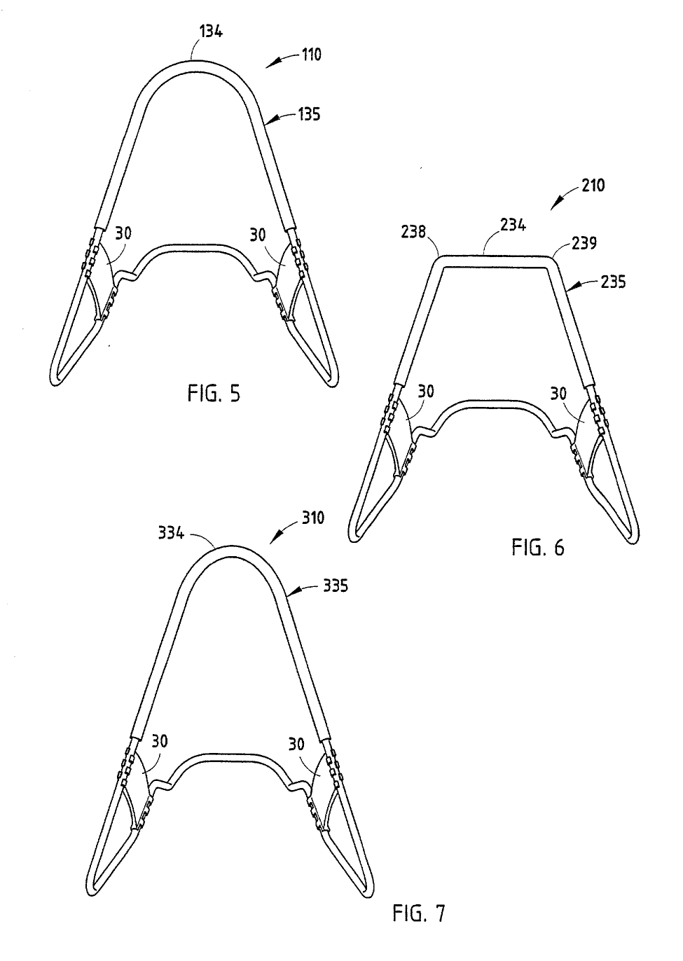

FIGS. 5-7 show alternative embodiments of the overall shape of the upper frame member 18 of devices, such as device 110, 210, and 310, which otherwise are identical to the first embodiment shown in FIGS. 1-4. The device in FIG. 5 has a somewhat more rounded junction 134 for the handle 135, while the device shown in FIG. 6 is somewhat wider, defining a substantially flat center section 234 providing a more forward gripping surface for use of the device still, however, with relatively rounded corners 238 and 239. Finally, in the embodiment shown in FIG. 7, section 334 of handle 335 is more narrowly acutely shaped to define a narrower entrance angle for smaller individuals. In each of these embodiments, the dimensions of the base forming frame member 16 are substantially the same as that of lower frame section 16, shown in the first embodiment, as are the overall dimensions of the device and the structure of the reinforcing members coupling the upper and lower frame members. The shape of the base can, however, be changed to match the shape of the upper frame member.

In each of the embodiments, the materials employed are substantially the same. It being understood, however, that larger sizes can be made for use by heavy adults. The diameter of the steel tubing can be increased as necessary, and the overall dimensions of the device scaled up to provide an adult size version of the balance stabilizing device.

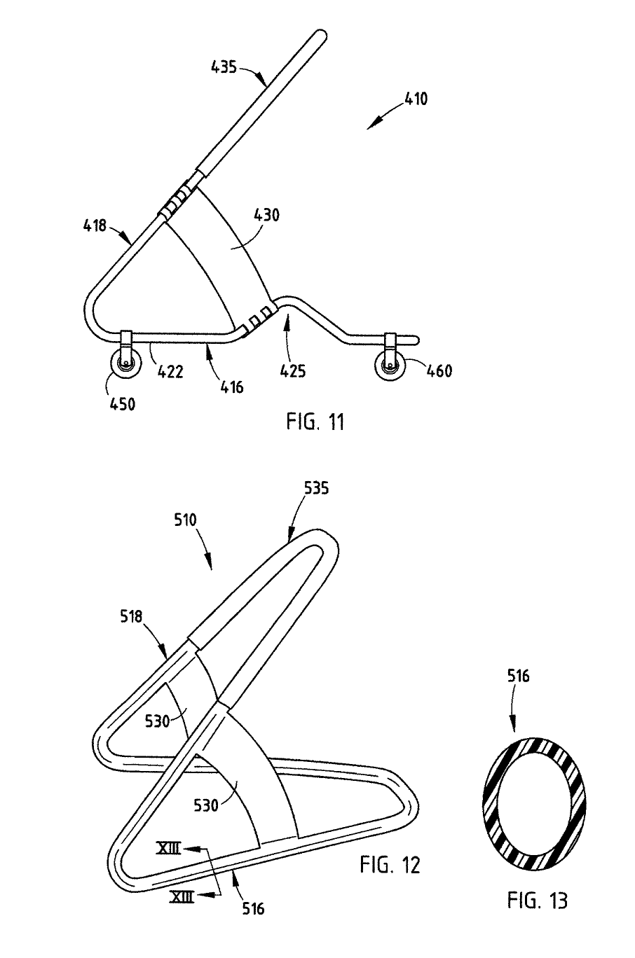

FIG. 11 shows yet another embodiment of the invention in which a device 410, having substantially the same structure as that of FIGS. 1-3, is shown with the lower frame member 416 equipped with an individual or a pair of forward rollers 460 and rearward rollers 450 such that the lower frame 416 is movably supported on three or four spaced-apart rollers 450 and 460 which can be conventionally mounted to the tubular member 416. Rollers 450 and 460 can be 360° swivel-type casters having a diameter of about 4 inches to allow the device to be used by individuals learning to inline skate or roller skate on smooth surfaces. In some embodiments, it may be desirable to have front and rear caster pairs 450, 460, respectively, be removable such that the device can be used in the winter months or otherwise for use on an ice surface or when the casters are installed for use on dry hard surfaces. If the device is to be used by elderly or infirm persons for assistance in mobility typically the rearward rollers 450 would not be employed, such that the rearward end of runner 422 and the corresponding left side runner would directly engage the support surface. The tubing for all of the above described embodiments is preferably bent into the shapes shown using a CNC tube bender, which is a commercially available machine.

Although the balance stabilizing device of the preferred embodiment of the invention was made of a tubular steel frame 14, it may be desirable in some embodiments to enlarge the frame structure somewhat and blow mold it of polypropylene or other suitable polymeric material such that the device remains relatively lightweight and strong. FIGS. 12 and 13 show such an embodiment in a device 510 which includes a lower generally U-shaped frame 516 and an integral upper U-shaped frame 518 with an integral bridge support 530 on each side. The overall shape of device 510, however, is substantially the same as in the earlier embodiments.

It will become apparent to those skilled in the art these various other modifications to the preferred embodiment of the invention as described herein can be made without departing from the spirit or scope of the invention as defined by the appended claims.

The invention claimed is:

1. A balance stabilizing device comprising:
a tubular frame having a lower, generally U-shaped continuous tubular member and an upper generally U-shaped continuous tubular member which are joined at a converging acute angle at the rear of the device to define an open area between the members into which a person can position themselves while gripping the upper member for stability.

2. The device as defined in claim 1 wherein the lower frame member defines ground engaging runners.

3. The device as defined in claim 1 where the lower frame member includes sides and an upwardly raised inverted V-shaped section on each side.

4. The device as defined in claim 3 and further including a pair of supports extending from the raised sections of the lower frame member to the upper frame on each side for supporting the upper frame with respect to the lower frame.

5. The device as defined in claim 4 wherein the upper frame defines a handle.

6. The device as defined in claim 5 wherein said handle is covered by a polymeric material.

7. The device as defined in claim 6 wherein said supports are injection molded of one of polypropylene and nylon and include alternately staggered opposed claws to allow the supports to snap-fit into said upper and said lower frames.

8. The device as defined in claim 7 wherein said frame members are integrally made of tubular steel.

9. The device as defined in claim 8 wherein said frame members are powder coated with a polyurethane material.

10. The device as defined in claim 9 wherein said frame members are 1″ OD 16-gauge zinc plated steel.

11. The device as defined in claim 1 wherein the lower frame member includes surface engaging rollers.

12. A balance stabilizing device comprising:
a blow molded tubular frame having a lower, generally U-shaped and an integral upper generally U-shaped member which converge at an angle of from about 40° to 50° to define an open area between the members into which a person can position themselves while gripping the upper member for stability, wherein integrally molded supports extend from the lower frame member to the upper frame on each side for supporting the upper frame with respect to the lower frame.

13. The device as defined in claim 12 wherein the upper frame defines a handle.

14. The device as defined in claim 12 wherein the lower frame member includes surface engaging rollers.

15. A balance stabilizing device comprising:
a tubular steel frame having a lower, continuously formed generally U-shaped member and an upper continuously formed generally U-shaped member which are joined at a converging angle of from about 40° to 50° to define an open area between the upper and lower members into which a person can position themselves while gripping the upper member for stability.

16. The device as defined in claim 15 where the lower frame member includes an upwardly raised section on each side.

17. The device as defined in claim 16 and further including a pair of supports extending from the raised sections of the lower frame member to the upper frame on each side for supporting the upper frame with respect to the lower frame.

18. The device as defined in claim 15 wherein the lower frame member defines ground engaging runners.

19. The device as defined in claim 15 wherein the upper frame defines a handle.

20. The device as defined in claim 19 wherein said handle is covered by a polymeric material.
